(19) United States
(12) Patent Application Publication
(10) Pub. No.: US 2011/0101707 A1
(43) Pub. Date: May 5, 2011

(54) VEHICLE LATCH AND METHOD OF OPERATING

(76) Inventors: Donald M. Perkins, Sterling Heights, MI (US); Gavriel Shafry, Wermelskirchen (DE)

(21) Appl. No.: 12/871,132

(22) Filed: Aug. 30, 2010

Related U.S. Application Data
(60) Provisional application No. 61/258,980, filed on Nov. 6, 2009.
(60) Provisional application No. 61/238,027, filed on Aug. 28, 2009.

(51) Int. Cl. E05B 65/12; E05C 3/12

(52) U.S. Cl. 292/199; 292/194; 292/201

(57) ABSTRACT

A latch assembly is disclosed herein, the latch assembly having: a motor for moving a gear of the latch assembly between a lock position, an unlock position; and a release position, the lock position locking the latch assembly, the unlock position unlocking the latch assembly and the release position allows a fork bolt of the latch assembly to be moved into an unlatched position; a first block out lever, the first block out lever being capable of movement between a first position and a second position, the first position preventing the gear from moving from a lock or unlock position to the release position; a second block lever, the second block out lever being capable of movement between a first position and a second position, the first position preventing the gear from moving from the release position to the unlock position; and a fork bolt detent, the fork bolt detent being capable of movement between a fork bolt blocking position wherein movement of the fork bolt to an unlatched position is blocked and a fork bolt release position wherein movement of the fork bolt to the unlatched position is allowed, the fork bolt detent being moved to the fork bolt release position when the gear is moved to the release position.

### CROSS REFERENCE TO RELATED PATENT APPLICATIONS

This application claims the benefit of U.S. Provisional Patent Application Nos. 61/238,027 filed Aug. 28, 2009 and 61/258,980 filed Nov. 6, 2009, the contents each of which are incorporated herein by reference thereto.

### BACKGROUND

Exemplary embodiments of the present invention relate to door, lift gate, glass window and movable panel latches and, more particularly, to latches for vehicles.

A vehicle frequently includes displaceable panels such as doors, windows, hood, trunk lid, hatch and the like which are affixed for hinged or sliding engagement with a host vehicle body. Cooperating systems of latches and strikers are typically provided to ensure that such panels remain secured in their fully closed position when the same is closed.

A latch typically includes a fork bolt that is pivoted between an unlatched position and a primary latched position when the door is closed to latch the door in the closed position. The fork bolt is typically held in the primary latched position by a detent lever that pivots between an engaged position and a disengaged position. The detent lever holds the fork bolt in the primary latched position when it is in the engaged position and releases the fork bolt when it is in the disengaged position so that the door can be opened.

The fork bolt is pivoted to the primary latched position by a striker attached to, for example, an associated door jamb, lift gate, moveable member such as a window etc., when the same is closed. Once in the primary latched position, the detent lever engages the fork bolt to ensure the assembly remains latched.

Accordingly, it is desirable to provide an automatically operated door latch assembly. More specifically, it is also desirable to provide an automatically operated door latch assembly that employs a device or motor to move the detent lever from the engaged position to the disengaged position in order to release the striker from the fork bolt as well as provide a locked and unlocked feature of the latch.

### SUMMARY OF THE INVENTION

In accordance with an exemplary embodiment of the invention, a latch assembly is provided, the latch assembly having: a motor for moving a gear of the latch assembly between a lock position, an unlock position; and a release position, the lock position locking the latch assembly, the unlock position unlocking the latch assembly and the release position allows a fork bolt of the latch assembly to be moved into an unlatched position; a first block out lever, the first block out lever being capable of movement between a first position and a second position, the first position preventing the gear from moving from a lock or unlock position to the release position; a second block lever, the second block out lever being capable of movement between a first position and a second position, the first position preventing the gear from moving from the release position to the unlock position; and a fork bolt detent, the fork bolt detent being capable of movement between a fork bolt blocking position wherein movement of the fork bolt to an unlatched position is blocked and a fork bolt release position wherein movement of the fork bolt to the unlatched position is allowed, the fork bolt detent being moved to the fork bolt release position when the gear is moved to the release position.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a schematic illustration of an exemplary embodiment of the present invention;

FIG. 2 is another schematic illustration of an exemplary embodiment of the present invention;

FIG. 3 is a view of an exemplary latch in a locked position;

FIG. 4 is a view of an exemplary latch in an un-locked position;

FIG. 5 is a view of an exemplary latch in a released position;

FIG. 6 is another view of an exemplary latch in a locked position;

FIG. 7 is another view of an exemplary latch in an un-locked position;

FIG. 8 is another view of an exemplary latch in a released position; and

FIG. 9 is a view of an alternative exemplary embodiment of the present invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to an apparatus and method for providing a latch assembly. Furthermore, exemplary embodiments are directed to a latch assembly having a single motor for manipulating the latch into anyone of three states, lock, unlock and released.

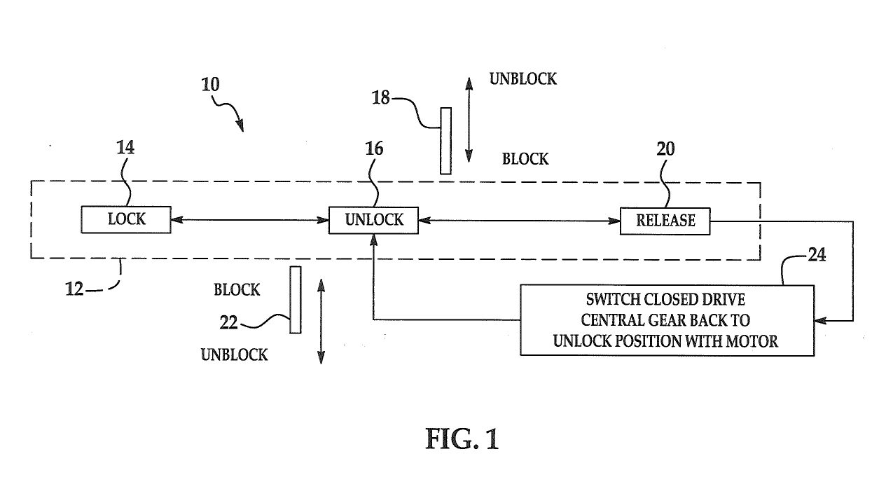

FIG. 1 schematically illustrates an actuator 10 of a latch assembly of an exemplary embodiment of the present invention. Movement of a central gear 12 of the latch assembly is illustrated schematically. Central gear is moved by a motor from a locked position 14 wherein a door cannot be opened to an unlocked position 16 wherein the door can be opened. Also shown is a first block out lever 18 that moves from a block position (wherein the central gear cannot move to a release position) to an unblock position (wherein the central gear can be moved by the motor to a release position). Movement of the central gear to the release position also moves a fork bolt detent from a fork bolt blocking position (wherein movement of the fork bolt to an unlatched position is blocked) to a fork bolt release position (wherein movement of the fork bolt to the unlatched position is allowed). The fork bolt detent being moved to the fork bolt release position when the gear 12 is moved to the release position.

In order to move the first block out lever 18 to the unblock position an inner handle or outer handle of the latch assembly must be pulled or actuated by an operator and the motor or a motor control unit receives a signal from the inner handle or outer handle or alternatively a micro switch to drive the motor. Thereafter, the motor drives the central gear to the release position and a fork bolt is moved to an unlatch position. When the fork bolt moves to an unlatch position a second block out lever 22 is moved from an unblock position to a blocked position, the blocked position prevents the central gear from being driven from the release position back to the locked position by the motor. This may cause an undesirable situation wherein the latch is locked.

Once the fork bolt is moved to an unlatch position a micro switch 24 is actuated and a signal is sent to a motor controller to drive the motor and the central gear to the unlocked position. However and as discussed above, movement of the fork bolt to the unlatched position causes the second lock out lever to move to the blocked position to prevent the central gear from being driven completely to the locked position from the released position.

The second block out lever is moved to the unblock position when the fork bolt is moved from the unlatched position to a secondary or a primary or latched position thereafter the central gear is then free to move from the locked to the unlocked position. At this point the central gear can be moved back and forth from the locked and unlocked positions.

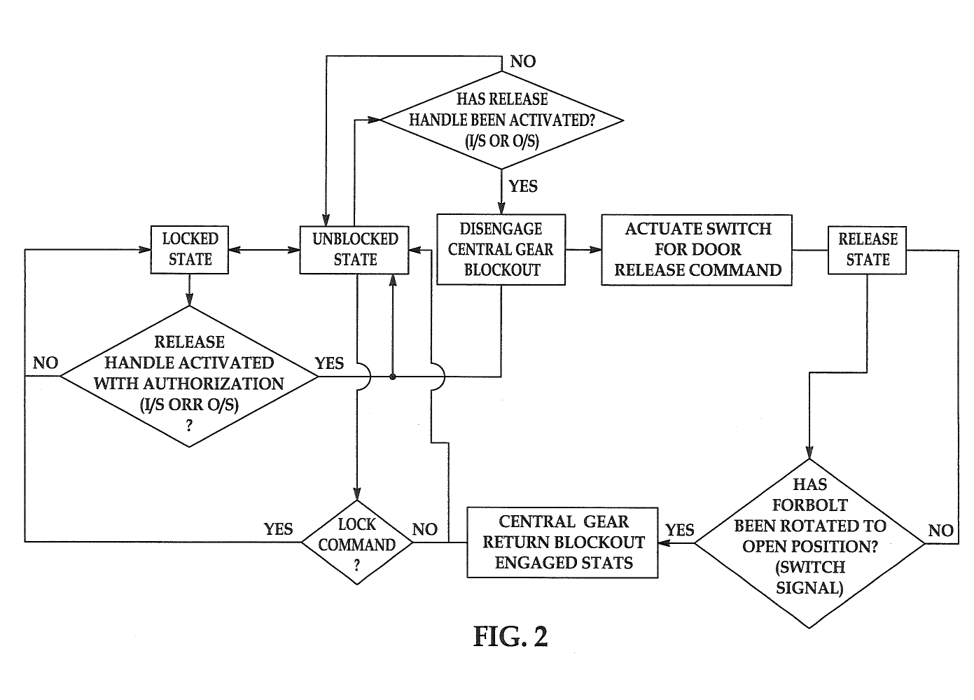

FIG. 2 also illustrates schematically an exemplary embodiment of the present invention.

Accordingly an actuator for a side door of a vehicle or alternatively any gate of the vehicle is provided and uses a single motor to provide various functions of the vehicle latch, including the lock and unlock function as well as the electrical release (opening) of the door or the gate. A single motor actuates the latch to move from the locked status through the unlocked status to the released (open) status.

As described above the actuator or central gear is mechanically blocked in the unlocked position, until any of the inside or outside release (open) handle is pulled to release the further movement of the system to fulfill the release function. In addition, the device is also mechanically blocked by a device driven by the fork bolt, the striker or any other device providing the door closed position.

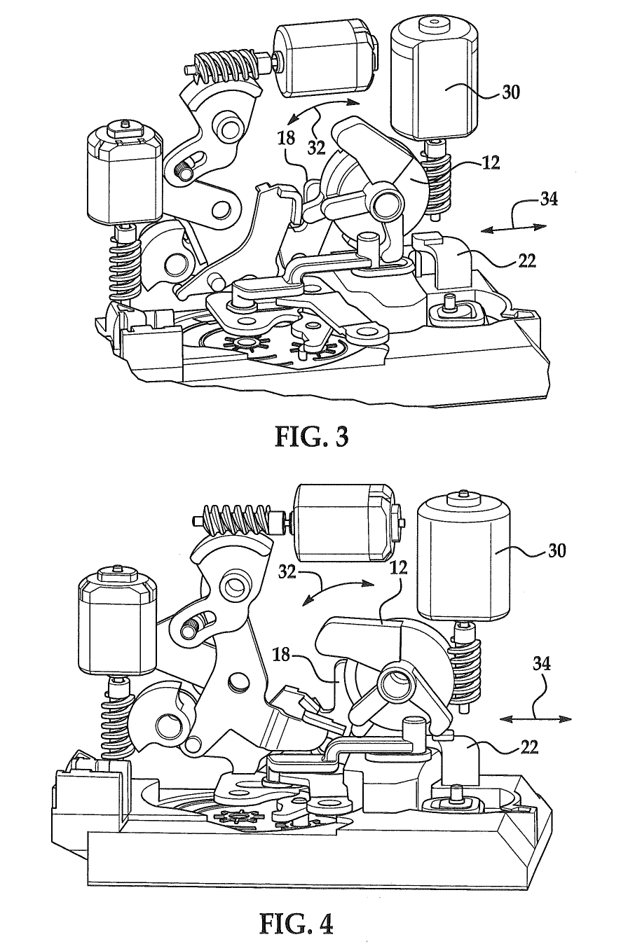

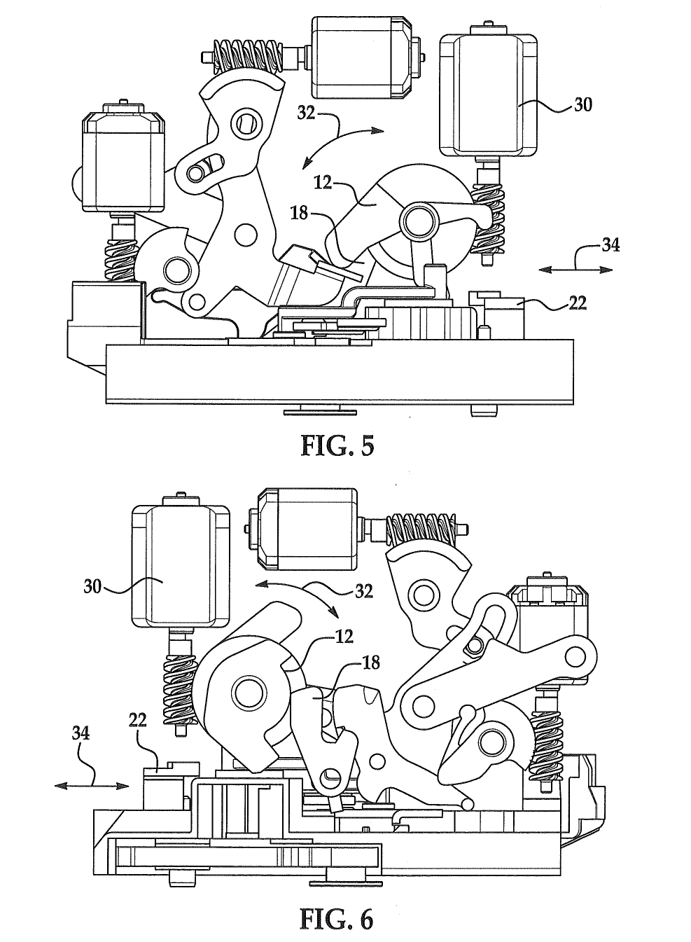

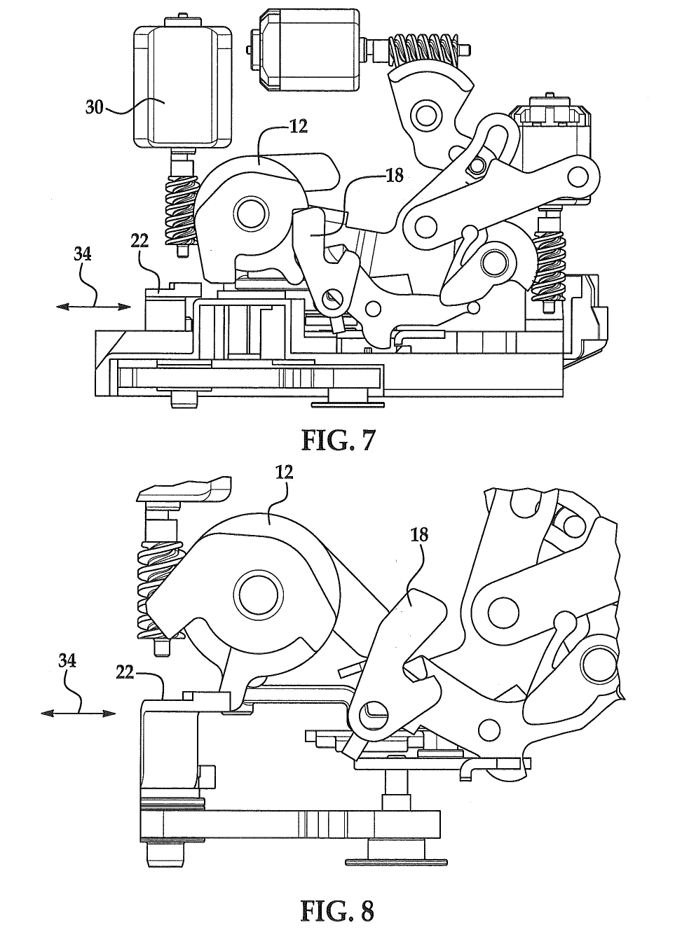

Referring now FIGS. 3-8 portions of an exemplary embodiment of the present invention are illustrated. FIG. 3 shows the central gear 12 in the locked position and first block out lever 18 in the block position. Also shown is motor 30 that drives the central gear in the directions of arrows 32 from the lock position to the unlock position to release position and back therefrom. Although other motors are shown in the FIGS. they are for other features of a latch system, which may or may not be used with exemplary embodiments of the present invention. FIG. 4 shows the central gear 12 in the unlock position wherein first block out lever 18 is still in the block position and FIG. 5 shows the central gear in the release position wherein the first block out lever 18 is in the unblock position. Also shown in FIGS. 3-5 is the second block out lever 22 that moves in the direction of arrows 34 between a block and unblock position. As discussed above movement of lever 22 in the directions of arrows 34 is facilitated by the movement of the fork bolt.

FIGS. 6, 7 and 8 are opposite side views of FIGS. 3, 4 and 5 illustrating the lock, unlock and release positions.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

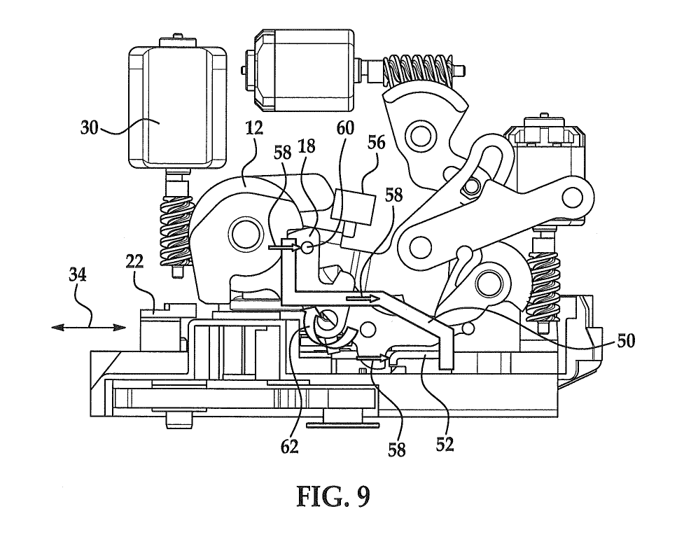

Referring now to FIG. 9 an alternative exemplary embodiment is illustrated here the actuator further comprises a translating member 50 that is driven by the detent releasing lever 52, which in turn drives the first mechanical block or first block out lever 18 to a position that will contact a switch 56 to provide a signal indicative of the position of the detent releasing lever. In one non-limiting embodiment and as illustrated, the translating member 50 is moved in the direction of arrows 58 by the detent releasing lever 52 and the translating member engages a feature 60, which in turn drives the block out lever 18 in the direction of arrow 62 to a position that will cause lever 18 to contact switch 56 and provide a signal indicative of the position of the detent releasing lever 52 as well as and for some control protocols the position of the lever 18 thus a single switch may be used for multiple functions to reduce the number of required switches and circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch assembly, comprising:
a motor for moving a gear of the latch assembly between a lock position, an unlock position; and a release position, the lock position locking the latch assembly, the unlock position unlocking the latch assembly and the release position allows a fork bolt of the latch assembly to be moved into an unlatched position;
a first block out lever, the first block out lever being capable of movement between a first position and a second position, the first position preventing the gear from moving from the lock or unlock position to the release position;
a second block lever, the second block out lever being capable of movement between a first position and a second position, the first position preventing the gear from moving from the release position to the unlock position; and
a fork bolt detent, the fork bolt detent being capable of movement between a fork bolt blocking position wherein movement of the fork bolt to an unlatched position is blocked and a fork bolt release position wherein movement of the fork bolt to the unlatched position is allowed, the fork bolt detent being moved to the fork bolt release position when the gear is moved to the release position.

2. An actuator for a latch assembly of a vehicle, the actuator using a single device to perform the function of manipulating the latch into a lock position, an unlock position and a release position.

3. The actuator as in claim 2, wherein the single device is a motor.

4. The actuator as in claim 3, wherein the motor drives a central gear into a lock position, an unlock position and a release position and the actuator further comprises a first mechanical block for preventing the central gear from moving to the release position unless a first predetermined condition has occurred.

5. The actuator as in claim 4, wherein the first predetermined condition is the movement of an inside or outside release handle.

6. The actuator as in claim 4, wherein the motor drives the central gear from the release position to the unlock position and the actuator further comprises a second mechanical block for preventing the central gear from moving to the unlock position from the release position unless a second predetermined condition has occurred.

7. The actuator as in claim 6, wherein the second predetermined condition is movement of a fork bolt from an unlatched position to a latched position.

8. The actuator as in claim 4, further comprising a translating member configured and positioned to be driven by the detent releasing lever, the translating member drives the first mechanical block to a position that will contact a switch to provide a signal indicative of the position of the detent releasing lever.
